(19) United States
(12) Patent Application Publication
(10) Pub. No.: US 2008/0133727 A1
(43) Pub. Date: Jun. 5, 2008

(54) AUTOMATIC REGISTRY COMPOSITION WHEN NETWORKS COMPOSE

(75) Inventors: Fatna Belqasmi, Montreal (CA); Roch Glitho, Ville Saint Laurent (CA); Rachida Dssouli, Montreal (CA)

Correspondence Address: ERICSSON CANADA INC.;PATENT DEPARTMENT, 8400 DECARIE BLVD., TOWN MOUNT ROYAL, QC, H4P 2N2, omitted

(73) Assignee: TELEFONAKTIEBOLAGET LM ERICSSON (PUBL), Stockholm (SE)

(21) Appl. No.: 11/614,808

(22) Filed: Dec. 21, 2006

Related U.S. Application Data
(60) Provisional application No. 60/868,492, filed on Dec. 4, 2006.

(51) Int. Cl. G06F 15/173

(52) U.S. Cl. 709/223

(57) ABSTRACT

A registry composition entity coordinates the composition of two or more individual registries in separate networks into a merged registry when said networks compose. The registry composition entity comprises a coordination module to enable communication with remote registry composition entities in other networks, a composability check module for negotiating a composition agreement with composition modules of other registry composition entities; and a composition manager to execute the composition agreement to create said merged registry.

### RELATED APPLICATIONS

This application claims the benefit of U.S. Provisional Patent Application 60/868,492 filed Dec. 4, 2006, which is incorporated herein by reference.

### TECHNICAL FIELD

The present invention relates generally to automatic composition of networks and, more particularly, to a method and system for composing registries and other information databases during network composition.

### BACKGROUND

In the near future, consumers are expected to carry multiple devices that communicate with one another to form small, personal area networks (PANs) that move with the user. In a given area, there may be many users, each with his/her own PAN. The PANs of different users are likely to comprise different devices, use different technologies, and have different resources and capabilities. It would benefit users to make the resources and capabilities of one PAN available to other PANs. For example, one PAN may have Internet access that can be shared with other PANs.

Network interworking allows the sharing of resources between networks so that users in one network can have access to resources in another network. BLUETOOTH and IEEE 802.15 both allow interworking between PANs. However, such interworking typically requires manual configuration and off-line negotiation.

The concept of network composition is gaining acceptance as a viable technique for the seamless and automatic creation of ad-hoc networks without user intervention. Automatic network composition enables interworking between networks “on the fly” in a manner that is transparent to the user. For example, the Ambient Networks Project is currently developing standards for networks called Ambient Networks. An Ambient Network can be defined as one or more network nodes and/or devices that share a common network control plane called the Ambient Control Space (ACS). The ACS contains all of the network control and management functions, which are organized into functional areas (FAs). Each FA represents a different management task (e.g., QoS, mobility, composition, security, congestion control, etc.). The ACS includes two interfaces: the Ambient Network Interface (ANI) and the Ambient Service Interface (ASI). The ANI enables communication between different Ambient Networks, and the ASI allows access to the services offered by the Ambient Network. The ACS enables automatic composition of networks in a transparent fashion, without manual configuration and off-line negotiation, while taking into account user needs, preferences, locations, and devices.

Current work on Ambient networks addresses the problem of seamless interworking between networks, but fails to address the problem of how resources in the composed network should be consolidated. As an example, consider a scenario where two PANs, each PAN having its own registry for a specific type of information, compose. After composition the composed network includes two separate registries containing the same type of information. While the information in both registries is available to clients in the composed network, it is not be convenient for clients to interact with two databases to find desired information. Therefore, it would be beneficial to users if registries and other databases could be consolidated during network composition.

### SUMMARY

The present invention relates to a method and system for composing two or more individual registries in separate networks into a merged registry when the separate networks compose. Each of the networks being composed includes a registry composition entity (RCE). The RCEs in the separate networks communicate with one another to coordinate the composition of the individual registries existing in the separate networks prior to composition into a merged registry for the composed network. In one exemplary embodiment, the registry composition entity comprises a coordination module to enable communication with remote registry composition entities in other networks, a composability check module for verifying the composability of the individual registries and for negotiating a composition agreement with remote registry composition entities, and a composition manager to execute the composition agreement to create the merged registry.

The merged registry may comprise one or more constituent registries. The constituent registries in a merged registry may exist prior to composition of the registries, or may be created during the composition process. In one embodiment, a merged registry is created by logically linking constituent registries existing prior to composition to enable interworking between the constituent registries. In another embodiment, the merged registry is created by creating a new registry for shared resources of the pre-composition registries, and logically linking the new registries with the pre-existing registries. In another embodiment, the merged registry is created by transferring the contents of the pre-existing registries to a newly-created registry.

In one exemplary embodiment, an overlay network is created during the registry composition process to enable interworking between post-composition registries. The overlay network is created by assigning post-composition registries in the composed network to groups, creating a virtual registry for each group, and selecting a post-composition registry in each group to support the virtual registry for that group. The virtual registries are linked to enable interworking between the virtual registries. The post-composition registries are linked to corresponding virtual registries.

### BRIEF DESCRIPTION OF THE DRAWINGS

FIG. 1 illustrates a network according to one exemplary embodiment of the invention.

FIG. 2A illustrates an exemplary registry composition entity for composing registries.

FIG. 2B illustrates an exemplary node on which a registry composition entity is implemented.

FIG. 3 illustrates the composition of individual registries into merged registries.

FIGS. 4A-4C illustrate methods for creating merged registries.

FIG. 5 illustrates a composed network including an overlay network to enable interworking between post-composition registries.

FIG. 6 illustrates an exemplary procedure for creating an overlay network.

FIG. 7 illustrates an exemplary virtual registry for the overlay network.

FIG. 8 illustrates an exemplary procedure for publishing information to a merged registry.

FIG. 9 illustrates an exemplary method for discovering information in a composed registry.

FIG. 10 illustrates an exemplary procedure for publishing registry descriptions for post-composition registries in a composed network.

FIG. 11 illustrates a use case scenario for composing registries.

### DETAILED DESCRIPTION

Network composition enables “on the fly” interworking between heterogeneous networks without manual configuration or prior offline negotiation. Network composition results in the creation of a new post composition network, referred to herein as the composed network, in which resources of the pre-composition networks may be shared.

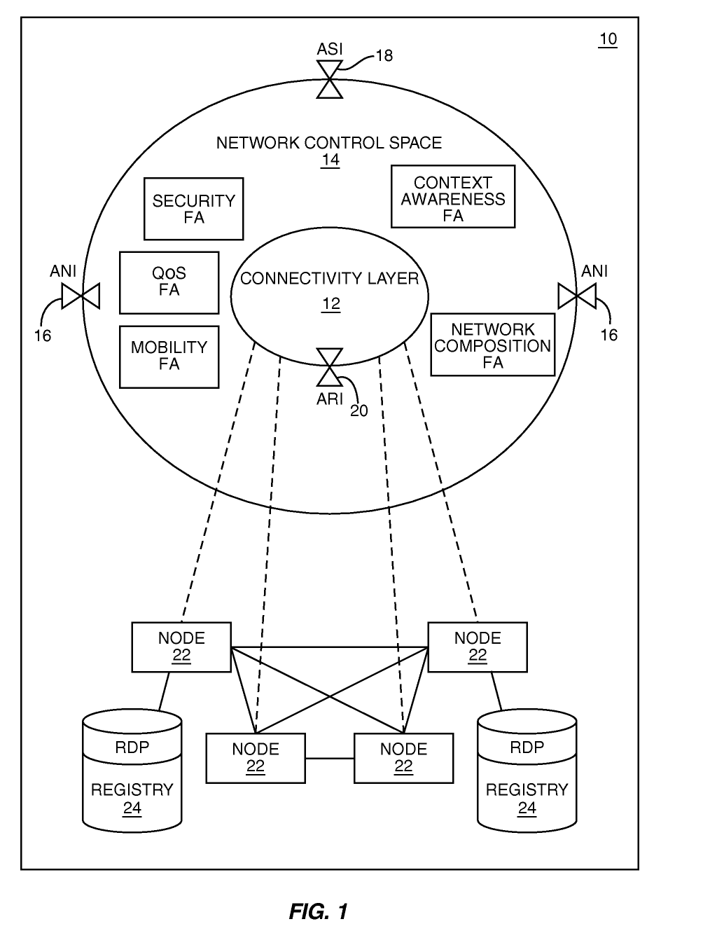

FIG. 1 illustrates a composable network 10 (e.g., Ambient Network) according to one exemplary embodiment. The composable network 10 shown in FIG. 1 is based on the Ambient Network architecture proposed by the Ambient Network Project as described in “Ambient Networking: Concepts and Architecture (IST-2002-2.3.1.4), which is incorporated herein by reference. The network 10 may comprise one or more network nodes 22 that reside in the connectivity layer 12 of the network 10 and share a common network control space 14. The connectivity layer 12 comprises the logical and physical resources of the network 10, which may include one or more registries 24. There is one common network control space 14 for all of the nodes 22 in the network 10. The network control space 14 is logically present in the nodes 22. The network architecture does not imply a particular kind of implementation. The network control space 14 can be implemented on a central server or in a distributed fashion where nodes 22 implement parts of the network control space 14.

The network control space 14 comprises a set of control functions to enable interworking between networks 10. These control functions, also referred to as functional areas (FAs), each handle a specific management task, such as Quality of Service (QoS), mobility, security, context awareness, and network composition. The composition FA is responsible for composition related functions as will be hereinafter described. Depending on the type of composition, a new network control space 14 may be created for the composed network.

The network control space 14 includes three interfaces: the network interface 16, the service interface 18, and the resource interface 20. The network interface 16 provides a standard mechanism to enable cooperation between the network control spaces 14 of different networks 10 and hides the complexities of the underlying network technologies so that networks 10 using different technologies appear the same. The networks use a technology independent signaling protocol, such as the Generic Ambient Network Signaling Protocol (GANS), to exchange information over the network interface 16. Applications or clients residing on network nodes 22 use the service interface 18 to access the services provided by the network control space 12. When two networks 10 compose, a single service interface 18 is created for the composed network. The resource interface 20 provides a mechanism to manage the resources residing in the connectivity layer. Applications use the resource interface to access the resources residing on network nodes 22 in the connectivity layer 14.

Individual networks 10 can compose to form composed networks, which can also compose with other networks 10. Network composition enables dynamic and instantaneous interworking of heterogeneous networks 10 on demand and in a transparent fashion without manual configuration or offline negotiation. When two networks 10 compose, they communicate with one another over the network interface 16 to negotiate a network composition agreement (NCA). The NCA specifies the resources that will be shared, the services that will be provided, and the policies that will be implemented to coordinate interoperation of the network control spaces 14 of the pre-composition networks 10. The result of the composition may be a newly composed network that includes all of the logical and physical resources contributed by the pre-composition networks 10. Composition, however, does not necessarily result in a new composed network.

Three types of network composition are possible: network interworking, control sharing, and network integration. In the first type, each network 10 controls and manages its own resources and no composed network is created. In the second type, some of the resources of the composing networks 10 are contributed to a new composed network. This composed network has its own logical network control space. The composing networks 10 exercise joint control over the shared resources and keep control over the remainder of their own resources. In the third type of network composition, all of the participating networks 10 merge into a new composed network. The composed network consists of all logical and physical resources in the composing networks. A new logical network control space 14 is created during composition and manages the composed network.

The pre-composition networks 10 may include registries 24 that can be accessed by applications. A registry 24 is any authoritative store of information or repository of data, such as a database. The registries 24 hosted by the pre-composition networks 10 can be of different types (e.g. centralized, distributed), they can store different types of information using different formats (e.g. Object oriented database, relational database), and they can rely on different interfaces to access the stored information (i.e. protocols such as P2P information discovery protocols or programming interfaces such as UDDI APIs).

According to the present invention, the concept of composition is extended beyond simple network composition to include composition of registries 24 existing in the pre-composition networks 10. When two networks 10 compose, two or more individual registries 24 in the constituent networks 10 are merged into a single logical registry, referred to herein as a merged registry 26. As used herein, the term “merge” does not necessarily imply the physical merging of the registries 24, but also includes the logical linking of registries 24 so that the combined resources appear to an application in the composed network as a single registry 24. Clients are provided the ability to automatically and seamlessly access the content of the various post composition registries that comprise the merged registry 26. This objective is achieved by providing an overlay architecture for information discovery and publication after network composition.

According to the present invention, a new functional entity in the network control space 14 called the registry composition entity (RCE) 30 is created to coordinate the composition of registries 24 and the creation of the overlay network 50. The RCE 30 may be incorporated into the composition FA, or may be a separate FA. Additionally, a registry discovery protocol (RDP) is added to each registry 24 to enable the automatic discovery of registries 24. The RDP is needed for peer-to-peer and mobile ad hoc networks 10 so that the networks 10 can acquire the addresses of existing registries 24 when they join or compose with an existing network 10.

The composition process for registry composition should preferably satisfy the following requirements:
(R1) The composition process should make it possible to verify the degree of composability of the registries 24 prior to composition. It may not be possible to compose them or the composition may be too costly.
(R2) The verification of the composition process must take much less time than the composition process itself.
(R3) The composition process should allow for composition in a wide range of scenarios and non-composability should be the exception. In the specific case of Web services as an example, the solution must support the composition of different types of registries 24. These registries 24 may use very different publication/discovery mechanisms (e.g. centralized, peer-to-peer) and protocols (e.g. HTTP, SMTP).
(R4) The composition process should support all three types of network composition (i.e. inter-working, control sharing and integration).
(R5) The composition process should scale in terms of the number of networks that compose.
(R6) The composition process should provide a fully automated composition
(R7) The composition process should not take longer than the other key processes (e.g. composition of functional areas) of network (de)composition.
(R8) After composition, entities should still be able to discover and publish.
(R9) After composition, the publishing and discovery policies of the composed registries should not be violated.
(R10) After composition, decomposition should be possible. Decomposition should also meet requirements R4-R9.

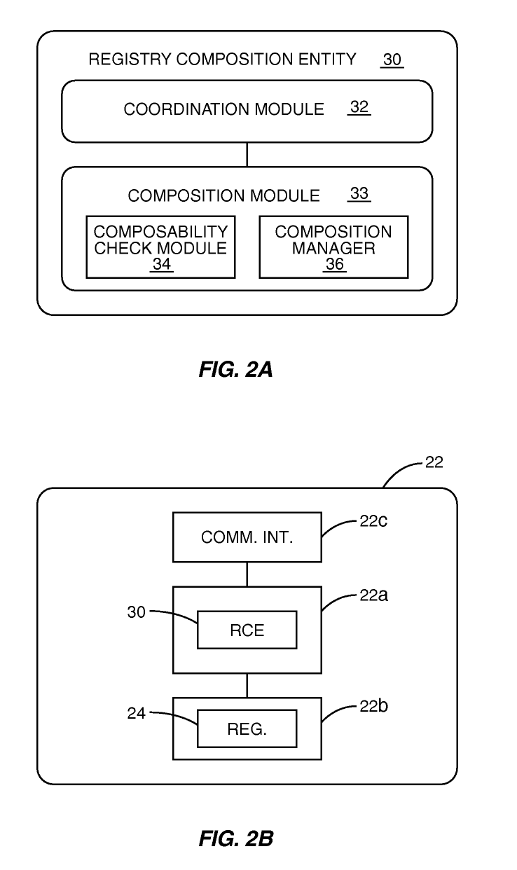

FIG. 2A illustrates the functional entities for one exemplary embodiment of the RCE 30. The RCE maybe be embodied in software stored in memory, or in a computer-readable media, and executed by a processor. The functions of the RCE may be centralized or distributed. In centralized embodiments, the functional entities comprising the RCE reside on a single node 22 of the network 10. In a distributed embodiment, the functional entities of the RCE 30 are distributed over two or more nodes 22 of the network 10.

The RCE 30 includes a coordination module 32, and a composition module 33. The coordination module 32 enables communications between RCEs for different networks 10. The composition module 33 represents the main functionality of the RCE 30. The composition module 33 includes a composability check module 34, and a composition manager 36. The composability check module 34 checks the degree of composability of the existing registries and negotiates a registry composition agreement (RCA) with the composition modules 33 of other constituent networks. The composition manager 36 is responsible for executing the registry composition agreement.

When the registry composition process is initiated, the composability check module 34 checks, for each registry 24, the protocol stack used for publication and discovery (e.g. UDDI APIs, SOAP v1 over HTTP v2 in the specific case of Web services), the type of discovery approach used (centralized, peer-to-peer), the information publication and discovery protocol, and the RDP version used. Using this information, the different composability check modules 34 for the different networks 10 communicate through the coordination module 32 to negotiate the registry composition agreement. The registry composition agreement may be incorporated into part of the network composition agreement. The composability check modules 34 negotiate the interworking protocols to determine which, if any, they will use, verify whether these protocols exist or can be generated on the fly, and verify whether it is possible to make them available by checking resources availability. The composability check modules 34 also negotiate the type of registry composition to use (e.g. create a new registry, use only existing registries). The composability check may indicate that composability is not feasible for several reasons. One example is when an interworking protocol is required but either this protocol cannot be found and cannot be generated on the fly, or it cannot be made available (e.g. security issues, resources not available).

FIG. 2B illustrates the relationship between a network node 22, the RCE 30, and registry 24. The node comprises a processor 22a, memory 22b, and a communications interface 22c for communicating with other nodes. While only one processor 22a is illustrated, those skilled in the art will appreciate that a node 22 may comprises two or more processors to carry out the functions of the node 22. The processor 22a implements the RCE 30 as described herein. Memory 22b comprises one or more memory devices, such as random access memory (RAM) or electronic erasable programmable memory (EEPROM), FLASH memory, magnetic media, optical media, etc. Memory 22b can be external or internal. If the node 22 includes a registry, the registry is stored in memory 22b. The communications interface 22c may comprise any standard wired or wireless interface, such as an Ethernet interface, WiFi interface, cellular interface, BLUETOOTH interface, etc.

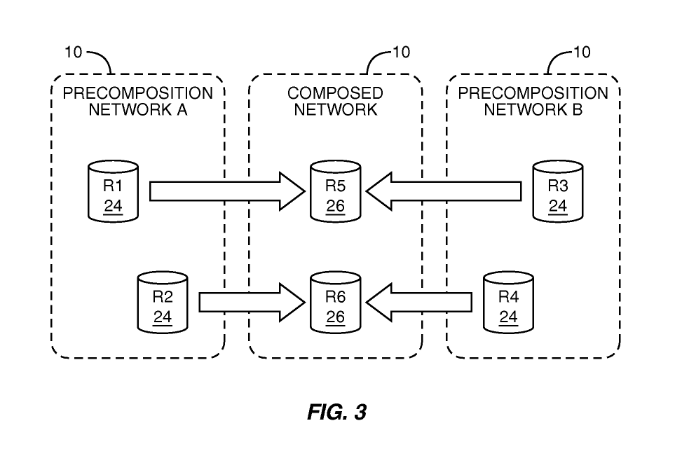

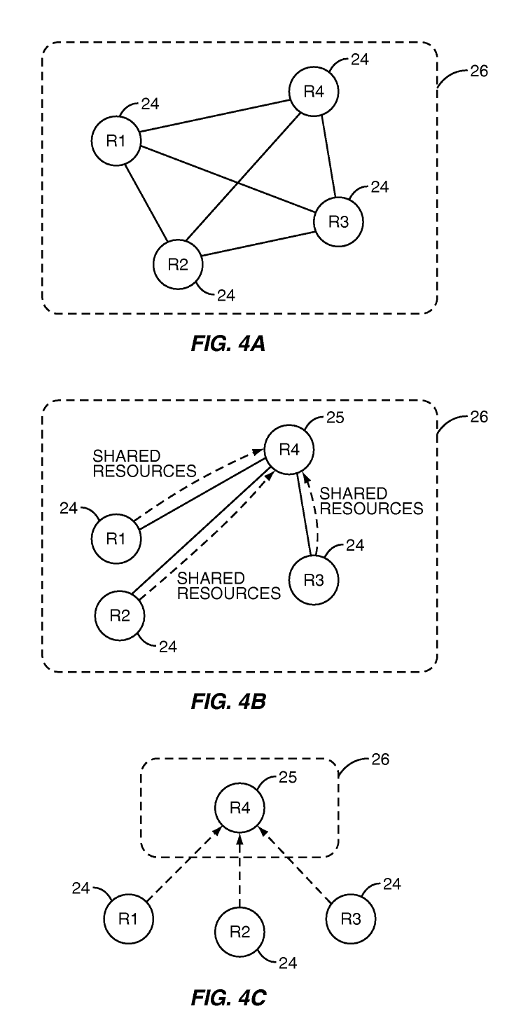

FIG. 3 illustrates the composition process. In this example, there are two precomposition networks 10, denoted as Network A and Network B. Network A and Network B compose to form the composed network. Prior to composition, Network A includes registries R1 and R2, while Network B includes registries R3 and R4. During the network composition process, registries R1 and R3 are composed or merged to form a first composed registry 26, denoted as registry R5. Registries R2 and R4 merge to form a second composed registry 26, denoted as registry R6. The composed registries 26 may comprise one or more constituent registries. Some of the constituent registries may exist prior to composition and some may be created during composition. Various methods for creating the composed registry 26 are illustrated in FIGS. 4A-4C.

Similar to network composition, there are three types of registry composition: non-integration, partial integration, and full integration. The registry composition agreement can take any one of three approaches to registry composition depending on the type of information contained in the registries.

The non-integration approach, illustrated in FIG. 4A, preserves the existing registries 24 and adds new resources to one of the existing registries 24. The pre-existing registries 24 are logically linked to form the merged registry 26. In this case, each network 10 retains controls of its own pre-existing registries 24. The registry discovery protocol (RDP), described below, enables one registry 24 to discover and request information in the other registries 24 to provide seamless access to information published in merged collective registry 26.

The partial integration approach, illustrated in FIG. 4B, creates a new registry 25 for shared resources and preserves the preexisting registries 24 for resources controlled by the individual networks 10. The pre-existing registries 24 are logically linked with the new registry 25 to form the merged registry 26. The shared components of the network are configured to communicate with the new registry 26. The RDP protocol enables each pre-composition registry 24 to discover and request information from the new registries 25 to provide seamless access to the shared content.

The full integration approach illustrated in FIG. 4C creates a new registry and adds the contents of the preexisting registries 24 to the new registry 25. The new registry 25 becomes the only constituent registry in the merged registry 26. The clients in the composed network are configured to communicate with the new registry 25. Alternatively, one of the existing registries 24 may be selected to serve as the composed registry 26. In this case, the contents of the other registries 24 are added to the one selected to serve as the composed registry 26.

When the non-integration or partial integration approaches are used, the preexisting registries 24 involved may use different protocols. Intercommunication between the constituent registries can be enabled by two mechanisms. The first is the use of gateways for interworking. The second is automatic protocol deployment. In the second case, if there are two registries R₁ and R₂ using protocols P₁ and P₂ respectively, registry R₁ can deploy protocol P₂ or registry R₂ can deploy protocol P₁. Another possibility is to specify a standard protocol P_{S} that is deployed in each registry that does not already support it. This last possibility will limit the number of protocols to deploy and hence provide more scalability.

To enable the automatic creation of gateways, the RCEs 30 can store the formal specifications for the needed protocols in memory. Each RCE 30 maintains the formal specifications of the IDP protocols of its network 10. When an interworking protocol is needed, the RCEs 30 elect a master RCE 30 and download the different protocol specifications to the elected master RCE 30. The master RCE 30 creates the required internetworking protocols, which will be downloaded and installed in the gateways. This approach implies that the gateways are programmable nodes 22, in order to make them change their behavior on the fly. It also implies that it must be possible to send active packets to the gateways to deploy the new protocol.

An alternative approach to automatic gateway creation is to use the RCEs 30 as protocol servers that store some commonly used interworking protocols. In this case, when an interworking protocol is needed, the RCEs 30 can check whether the needed protocol is stored in one of the other RCEs 30. If it is not, the composability check module 34 will fail, and the composition process will abort.

With protocol deployment, each RCE 30 maintains the RDP and IDP for its pre-composition network 10. When protocol deployment is needed, the RCEs 30 negotiate the protocol to deploy. Once the protocol is agreed upon, the protocol can be downloaded to and installed in all of the appropriate nodes 22. In this case, there I no need for protocol creation. This implies that all of these nodes 22 are programmable, and that it is possible to send active packets to each of them.

To enable seamless access to information in the composed network independently of the registry 24, 25 in which it is stored, an overlay network 50 for information discovery and publication can be created during the network composition process. The overlay network 50 may be based on a peer-to-peer (P2P) overlay mechanism. The use of a P2P overlay mechanism is advantageous because it allows distributed architectures, self reorganization, scalability (P2P overlay mechanisms enable nodes to join and leave “easily”), and provides a very good chance to discover existing information. The general requirements for the overlay network 50 are:
(R1) The overlay network 50 should be suitable for both centralized and peer-to-peer networks.
(R2) The overlay network 50 should be distributed and should allow dynamic self reorganization
(R3) The overlay network 50 should scale in the number of registries to compose.
(R4) The overlay network 50 should be independent of the type of composing networks and registries, and independent of the degree of network composition.
(R5) The overlay network 50 should not require changes in the clients.
(R6) The overlay network 50 should allow the usage of existing IDP protocols for information discovery and publication.
(R7) The overlay network 50 should be based on a simple information discovery and publication mechanisms.
(R8) The overlay network 50 should insure the discovery of existing information in a timely and efficient manner.
(R9) The overlay network 50 should provide fully automated access to the information, independent of the registry on which it is stored.

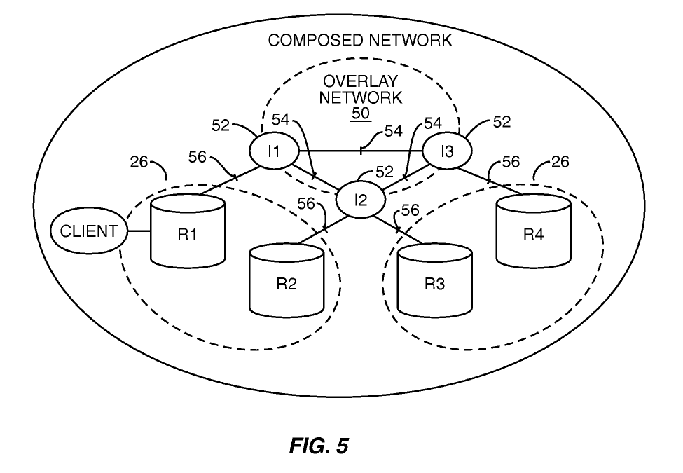

FIG. 5 illustrates the general architecture of a composed network and the overlay network 50. The composed network comprises four post composition registries R1-R4. In this example, the post composition registries R1-R4 comprise constituent registries forming parts of two composed registries 26. Some of these registries may exist before the composition, while others may have been created during the composition as previously described. In the latter case, no client is connected to these registries. The overlay network 50 provides a means for logically linking the post-composition registries R1-R4 to form the composed registries 26.

Registries R1-R4 may use different Information Discovery and Publication Interfaces (IDPIs) (i.e., protocol or programmatic interface) for access information. Examples of IDPIs include Structured Query Language (SQL), Universal Description Discovery and Integration (UDDI), and Java Description Object Query Language (JDOQL). In this example, Registry R1 implements a first IDPI (I1), Registries R2 and R3 implement a second IDPI (I2), and Registry R4 implements a third IDPI (I3).

The overlay network 50 logically links the registries R1-R4. One type of node makes up the overlay network: the Virtual Registry (VR) 52. A virtual registry 52 communicates with the other virtual registries 52 using an Overlay Interface 54, and with post-composition registries 24 using a Registry Interface 56. There is one virtual registry 52 in the overlay network 50 for each different IDPI used by the post composition registries R1-R4. In this example, the four post composition registries R1-R4 use three different IDPIs. Thus, there are three virtual registries 52 in the overlay network 50. Each virtual registry 52 supports only one IPDI. The clients (i.e. entities that want to publish or discover information) continue to communicate with pre-composition registries 24 that were part of their network 10 before composition. Each post composition registry R1-R4 communicates with the virtual registry 52 that supports the same IPDI.

A description is associated with each registry R1-R4. The description includes the type of the registry and a description of the information it contains. The main parts of this description are: the registry address, the registry type (e.g. UDDI, SQL, JDOQL. etc.), the type of information maintained by the registry (e.g. web services descriptions), and a brief description of the purpose of this information (e.g. printing, user location, hotel booking). The registry address includes the registry URI and the port number at which clients can communicate with that registry. Each post-composition registry 24 maintains its description. The registry description is intended for machine-to-machine communication between heterogeneous nodes, and therefore, XML may be used as the description language.

The overlay network 50 has a P2P overlay architecture with a fully interconnected topology. It uses a P2P protocol for information discovery and publication The requirements of the overlay protocol are:
(R1) It must be suitable for P2P. For this reason, it must be distributed and not relay on a central entity. It must also enable self-reorganization, and enable nodes to join and leave “easily”.
(R2) It must enable the publication of the registries' descriptions.
(R3) It must enable the discovery of the registry that contains given information (using the registries' descriptions).
(R4) The publication and discovery mechanisms must be timely efficient.
(R5) It must be as simple as possible, to allow its usage with small devices that require a small footprint.
(R6) It must be scalable in terms of the number of nodes that make up the overlay network.

Many existing P2P protocols can be used as an overlay protocol, such as Tapestry and Chord. Some existing middleware can also be used for the implementation of the virtual registry, such as JXTA. JXTA is a set of open protocols that allow devices on the network to communicate and collaborate in a P2P manner.

Table 1 below lists messages exchanged between virtual registries 52 in one exemplary embodiment.

TABLE 1
Overlay Messages

| | Description | Address | Parameters |
|---|---|---|---|
| Publish- | Publishes a description to the | Broadcast* | The description to |
| description | overlay network. Sent by a | *Depending on | publish. |
| | virtual registry to the overlay | the publication | |
| | network, after retrieving a | protocol used, it | |
| | description from a post- | can also be | |
| | composition registry. | Unicast or | |
| | | Multicast. | |
| Find- | Finds the post-composition | Unicast and | The description of |
| registry | registry that stores a given type | Anycast | the information to |
| | of information. Sent by a virtual | | retrieve. |
| | registry to the overlay network | | |
| | when it receives a discovery | | |
| | request from a post-composition | | |
| | registry, or when a retrieval | | |
| | request is received from another | | |
| | virtual registry. | | |
| Retrieve- | Retrieves information from a | Unicast | The target registry |
| information | post-composition registry. | | from which to |
| | Sent by a virtual registry (VR1) | | retrieve the |
| | to a virtual registry (VR2), | | information. |
| | when VR1 receives a | | The description of |
| | discovery request from a post- | | the information to |
| | composition registry and | | retrieve. |
| | discovers that the information | | |
| | to retrieve is stored in a | | |
| | registry belonging to the VR2 | | |
| | group. | | |
| Publish- | Publishes information to a | Unicast | The target registry |
| information | post-composition registry. | | where the |
| | Sent by a virtual registry (VR1) | | information is to be |
| | to a virtual registry (VR2), | | published. |
| | when VR1 receives a | | The information to |
| | publication request and | | publish. |
| | discovers that the information | | |
| | must be published to a post- | | |
| | composition registry, belonging | | |
| | to the VR2 group. | | |
| Response | Sends a response to a post- | Unicast | The target registry |
| | composition registry. Sent by | | where the response |
| | a virtual registry (VR1) to a | | is to be sent. |
| | virtual registry (VR2) when | | The response. |
| | VR1 receives a request from | | |
| | the post-composition registry | | |
| | via VR2. | | |

The overlay network 50 is created during the registry composition process. One RCE 30 may be selected during the negotiation of the registry composition agreement as the coordinating RCE to coordinate the composition of the registries and the creation of the overlay network 50. The coordinating RCE 30 determines the types, addresses, and IPDIs for post-composition registries 24.

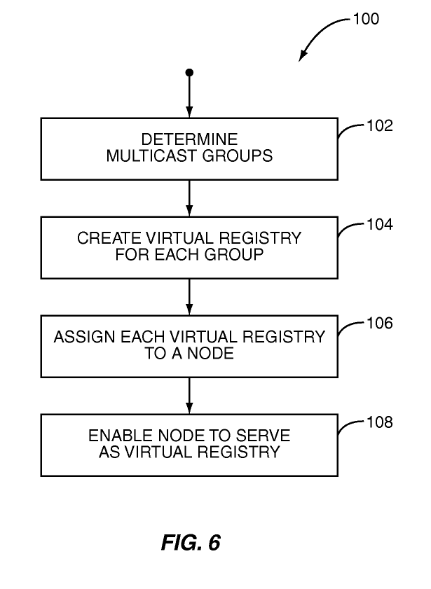

FIG. 6 illustrates an exemplary procedure 100 performed by the coordinating RCE 30. To create the overlay network 50, the coordinating RCE 30 starts by determining multicast groups comprising registries 24 that use the same IDPI (block 102). Next, it assigns a virtual registry 52 for each group (block 104), and then assigns the virtual registry 52 to a network node 22 (block 106). The selection of the network node 22 for each virtual registry 52 may use the mapping procedure described below. At the end of the registry composition process, it enables the selected network nodes 22 to serve as virtual registries 52 (block 108).

Each virtual registry 52 is mapped to a post-composition registry that supports the same IPDI. For centralized registries, one post-composition registry (R) with the same IDPI is selected to support the virtual registry 52. The post-composition registry to which the virtual registry 52 is mapped can be chosen either randomly, or based on available resources (e.g. processing power and memory, disc space). If the node 22 supporting the virtual registry leaves the network due to network decomposition, the virtual registry 52 is remapped to another post composition registry with the same IDPI. If no other registry uses the same IDPI, the virtual registry is removed. With distributed registries, mapping is done in the same way, except that the virtual registry 52 is mapped to the super-node of the selected post-composition registry. If the network representing the selected registry does not use the super-node concept, one of existing solutions for electing a super-node can be used. If the super-node leaves, the new super-node becomes the virtual registry 52.

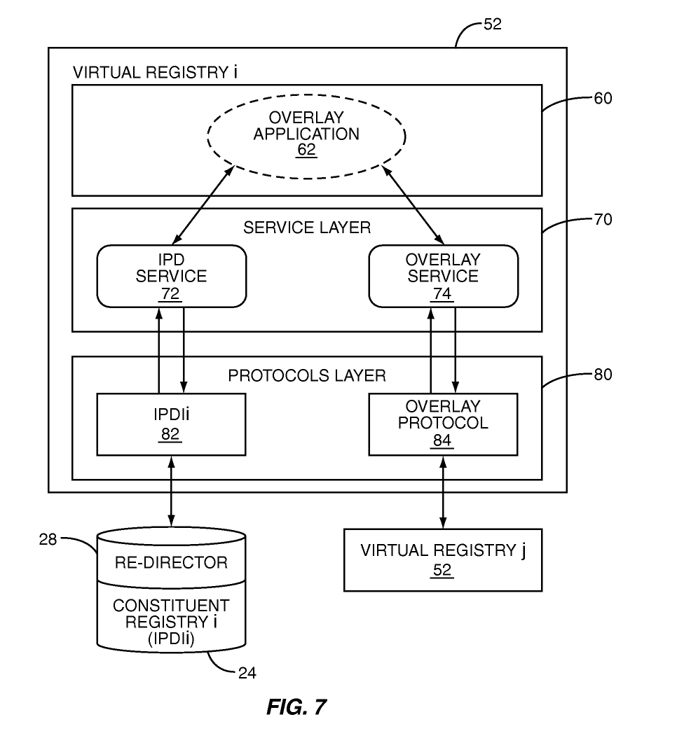

FIG. 7 illustrates one exemplary architecture for the virtual registry 52. The virtual registry 52 includes three layers: an application layer 60, a service layer 70, and a protocol layer 80. The application layer 60 includes an overlay application module 62. The overlay application module 62 includes the intelligence and the logic required for information discovery and publication. The service layer 70 includes an information discovery and publication (IDP) service module 72, and an overlay service module 74. The protocol layer 80 includes an Information Discovery and Publication (IDP) protocol stack 82 and an overlay protocol stack 84.

The IDP service module 72 includes an application programming interface (IDP API) that enables registries 24 to communicate with the overlay application 52. Exemplary service requests for the IDP API are listed in Table 2 below.

TABLE 2
IDP API Service Requests

| Service Request | Description |
|---|---|
| Get_description | Gets the description of the registries given |
| | as parameters. |
| Publish_info | Publishes information to a given registry. |
| Retrieve_info | Retrieves information from a given registry. |
| Send_response | Sends a given response to a given registry. The |
| | response may be created by the local overlay |
| | application or received from another post |
| | composition or virtual registry. It can |
| | be of any type such as: the requested information |
| | (e.g. in the case of information discovery), a success |
| | response (e.g. the information was correctly |
| | published) or an error response. |

The overlay service module 74 provides an overlay service API (OS API) to enable communication between overlay application modules 62 residing at different virtual registries 52. Exemplary service requests for the OS API are listed in table 3 below.

TABLE 3
OS API Service Requests

| Service Request | Description |
|---|---|
| Retrieve_info | Retrieves information from a given registry. |
| Publish_info | Publishes information to a given registry. |
| Send_response | Sends a given response to a given registry. The |
| | response may be created by the local overlay |
| | application or received from another post |
| | composition or virtual registry. It can be of any |
| | type such as: the requested information (e.g. in the |
| | case of information discovery), a success response |
| | (e.g. the information was correctly published) |
| | or an error response. |
| Publish_description | Publishes a registry description to the overlay |
| | network. |
| Find_registry | Finds the registry that stores given information, by |
| | interrogating the overlay network. |

The IPD service module 72 and the IPD protocol stack 82 provide the “Registry Interface” of the virtual registry 52. The overlay service module 74 and the overlay protocol stack 84 provide the “Overlay Interface”. The “Registry Interface” is used to communicate with post composition registries using the same IPDI supported by the virtual registry 52. To communicate with a post composition registry that supports a different IPDI, the application identifies the virtual registry 52 that supports the same IPDI as the target registry and sends the message to it. The selected virtual registry 52 will then transmit the message to the target registry and send the response, if any, back to the initiating node. The re-director module 28 is added to each post composition registry to enable it to redirect the requests received from clients to the overlay network 50 when needed.

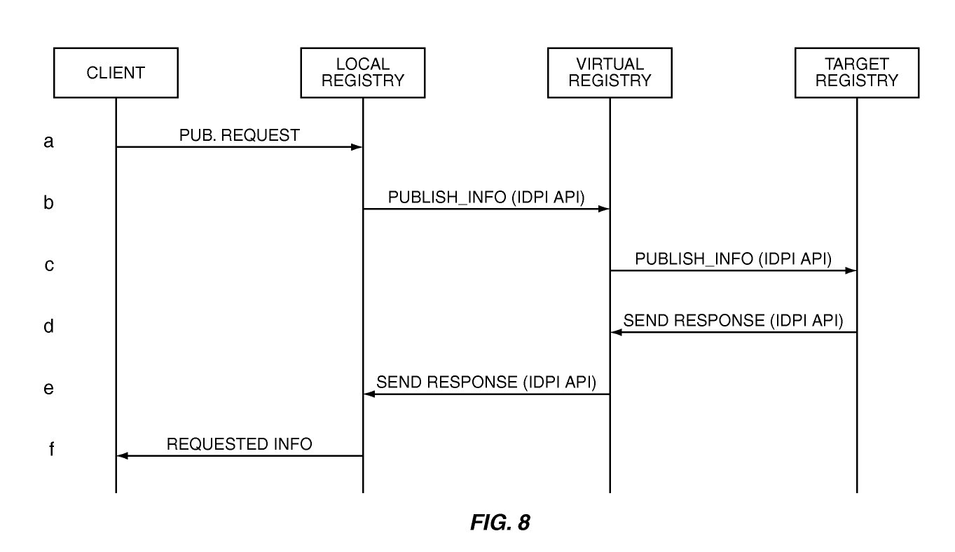

FIG. 8 illustrates an exemplary procedure for publishing information in the composed network. When a client wants to publish new information, it sends a publication request to the same pre-composition registry 24 that it was using before composition (a). This registry 24, referred to herein as the local registry, redirects the request to the virtual registry 52 (b), which identifies the target post-composition registry to which this information must be published, based on publication policies that can be specified either before or during the composition process. It then sends a publication request to the identified registry (c). The target registry may acknowledge the publication request to confirm successful publication (d-f).

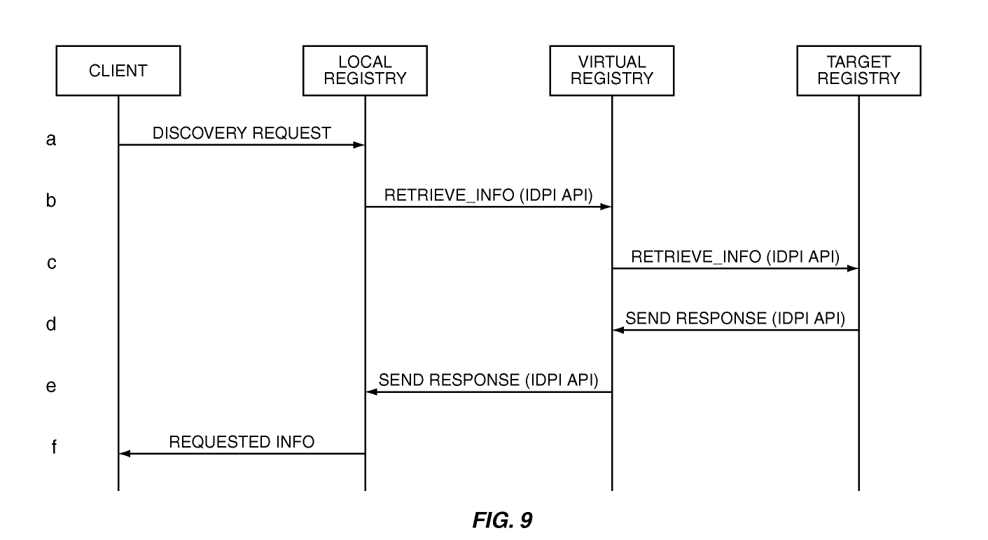

FIG. 9 illustrates an exemplary procedure for information discovery. To discover some information, a client sends a discovery request to a local registry 24 that it was using before composition (a). If the local registry 24 has the requested information, it sends it to the client. If not, it redirects the request to the virtual registry 52 (b), which discovers the target post-composition registry 24 that contains the requested information. The virtual registry 52 retrieves the requested information from the target registry (c, d) and responds to the discovery request (e). The local registry forwards the response to the client (f). The discovery of the target registry is based on the registry description that must be published to the overlay network 50 before the discovery process can begin.

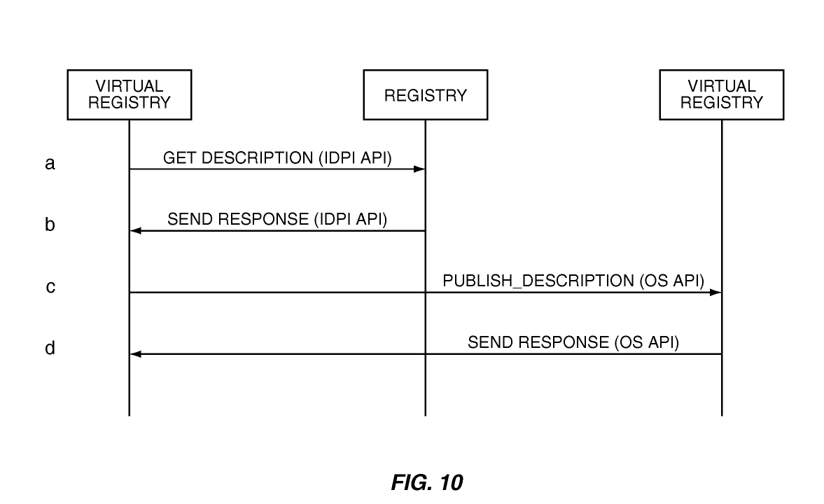

FIG. 10 illustrates an exemplary procedure for publication of the description of a post composition registry. When the overlay network 50 is created, each virtual registry 52 retrieves the descriptions from all of the post-composition registries 24 that are part of its related multicast group (a, b) and publishes them to the overlay network 50 (c, d). The different descriptions are distributed among some (or all) of the virtual registries 52, depending on which overlay publication protocol is used.

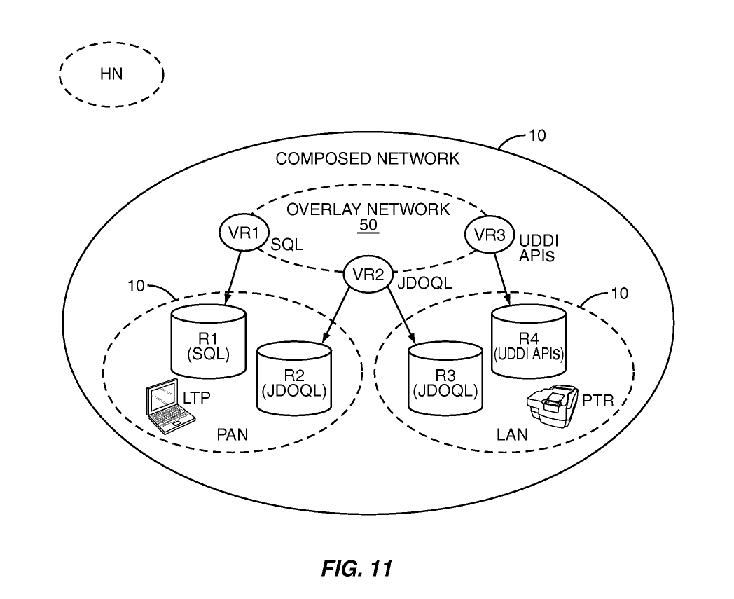

FIG. 11 illustrates one exemplary application of the present invention. John has a laptop LTP in which a printing application is installed. The laptop is part of John's personal area network PAN. The printing application on the laptop uses a web service (WS1) accessible via the Internet to print documents. A web service is a software system designed to support interoperable machine-to-machine interaction over a network. The web service architecture includes two main entities: the provider, and the requestor. The provider is the entity that provides the web service. The requestor is the entity that wants to make use of the service. To use the web service, the requestor has to know the address of the agent (software) that realizes the service. In this scenario, the requester is the printing application. The information about existing web services (e.g. address, printing characteristics) is stored in a relational database R1. When a printing is ordered, the application retrieves the service address from the database R1, connects to the service, and then prints the requested document. The web service is chosen according to the printing characteristics that it provides. John's PAN also has an object-oriented database (R2).

Normally, John's laptop accesses the Internet through an access point on John's home network HN. When John's PAN moves out of range of the HN, WS1 is out of reach. Meanwhile, John gets near a static local area network (LAN) that provides access to a printing web service (WS2), with the same characteristics required by the printing application. WS2 information is stored in a UDDI registry (R4). The static network hosts another registry (R3), which is an object-oriented database. When John's PAN gets close to the LAN, the two networks 10 compose. During network composition, the RCEs 30 of the two networks compose the four registries and create the overlay network 50. The overlay network 50 will be made up of three virtual registries: VR1 uses SQL as its IPDI, VR2 uses UDDI APIs as its IDPI, and VR3 uses Java Data Object Query Language (JDOQL) as its IDPI. JDOQL is an implementation of the Object Query Language, a query language standard for object-oriented databases. If John orders a document to be printed after the creation of the overlay network 50, the overlay network 50 is used and the printing application automatically gets the address of WS2 and prints the document.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of composing two or more individual registries in separate networks into a merged registry when said separate networks compose, said registry composition entity comprising:
communicating with one or more remote composition entities in other networks:
coordinating with the remote registry composition entities to compose individual registries existing in the separate networks prior to said composition into a merged registry for the composed network.

2. The method of claim 1 wherein coordinating with the remote registry composition entities comprises:
negotiating a composition agreement with said remote registry composition entities; and
executing the composition agreement to create said merged registry.

3. The method of claim 2 wherein executing the composition agreement to create said merged registry comprises creating said merged registry by linking said individual registries to enable interworking between said individual registries.

4. The method of claim 3 wherein linking said individual registries comprises creating an overly network linking said individual registries.

5. The method of claim 3 further comprising creating one or more gateways to enable interworking between said individual registries.

6. The method of claim 5 further comprising storing protocol specifications for the creation of said gateways.

7. The method of claim 3 further comprising storing interworking protocols to enable interworking between said individual registries.

8. The method of claim 7 further comprising transferring said interworking protocols to one or more of said remote registry composition entities.

9. The method of claim 3 wherein said registry composition entity downloads interworking protocols to enable interworking between said individuals registries from a protocol server

10. The method of claim 2 wherein executing the composition agreement to create said merged registry comprises creating a new registry for shared resources of the individual registries, and logically linking said new registry with said individual registries.

11. The method of claim 10 wherein linking said individual registries comprises creating an overly network linking said individual registries.

12. The method of claim 10 further comprising creating one or more gateways to enable interworking between said individual registries.

13. The method of claim 12 further comprising storing protocol specifications for the creation of said gateways.

14. The method of claim 10 further comprising storing interworking protocols to enable interworking between said individual registries.

15. The method of claim 14 further comprising transferring said interworking protocols to one or more of said remote registry composition entities.

16. The method of claim 10 wherein said registry composition entity downloads interworking protocols to enable interworking between said individuals registries from a protocol server

17. The method of claim 2 wherein executing the composition agreement to create said merged registry comprises creating a new merged registry for the resources of the individual registries.

18. A registry composition entity for composing two or more individual registries in separate networks into a merged registry when said separate networks compose, said registry composition entity comprising:
a coordination module to enable communication with remote registry composition entities in other networks; and
a composition module for coordinating with the remote registry composition entities to compose individual registries existing in the separate networks prior to said composition into a merged registry for the composed network.

19. The registry composition entity of claim 18 wherein the composition module comprises:
a composability check module for negotiating a composition agreement with composition modules of other registry composition entities; and
a composition manager to execute the composition agreement to create said merged registry.

20. The registry composition entity of claim 19 wherein said composition manager creates said merged registry by logically linking said individual registries to enable interworking between said individual registries.

21. The registry composition entity of claim 20 wherein the composition manager creates an overly network logically linking said individual registries.

22. The registry composition entity of claim 20 wherein the composition manager creates one or more gateways to enable interworking between said individual registries.

23. The registry composition entity of claim 22 wherein said registry composition entity stores protocol specifications for the creation of said gateways.

24. The registry composition entity of claim 20 wherein said registry composition entity stores interworking protocols to enable interworking between said individual registries.

25. The registry composition entity of claim 24 wherein said registry composition entity functions as a protocol server for downloading said interworking protocols by other registry composition entities.

26. The registry composition entity of claim 20 wherein said registry composition entity downloads interworking protocols to enable interworking between said individuals from a protocol server

27. The registry composition entity of claim 19 wherein said composition manager creates said merged registry by creating a new registry for shared resources of the individual registries, and logically linking said new registry with said individual registries.

28. The registry composition entity of claim 27 wherein the composition manager creates an overly network logically linking said individual registries.

29. The registry composition entity of claim 27 wherein the composition manager creates one or more gateways to enable interworking between said individual registries.

30. The registry composition entity of claim 29 wherein said registry composition entity stores protocol specifications for the creation of said gateways.

31. The registry composition entity of claim 27 said registry composition entity stores interworking protocols to enable interworking between said individual registries.

32. The registry composition entity of claim 31 wherein said registry composition entity functions as a protocol server for downloading said interworking protocols by other registry composition entities.

33. The registry composition entity of claim 27 wherein said registry composition entity downloads interworking protocols to enable interworking between said individuals registries from a protocol server

34. The registry composition entity of claim 19 wherein said composition manager creates said merged registry by creating a new merged registry for the resources of the individual registries.

35. A method of creating an overlay network for a composed network for information discovery and publication, said method comprising:
assigning registries of the composed network to groups;
creating a virtual registry in the overlay network for each group;
selecting a node in said composed network to support each of said virtual registries;
linking said virtual registries to enable intercommunication between the virtual registries;
linking said registries in said composed network to a corresponding one of said virtual registries in said overlay network to enable communication between said registries and the corresponding virtual registry.

36. The method of claim 35 wherein registries assigned to the same group share a common information discovery and publication interface.

37. The method of claim 35 wherein selecting a node in said composed network to support said virtual registry comprises selecting a node supporting one of said registries in said group.

38. The method of claim 37 further comprising reassigning the virtual node to a new network node when the supporting node leaves said network.

39. The method of claim 37 wherein selecting a node supporting one of said registries in said group comprises selecting a node functioning as a super node.

40. A registry composition entity for composing two or more individual registries in separate networks into a merged registry when said separate networks compose, said registry composition entity comprising
a processing module configured to assign registries of the composed network to groups, create a virtual registry in the overlay network for each group, and select a node in said composed network to support each of said virtual registries.

41. The registry composition entity of claim 40 wherein said processing module assigns registries sharing a common information discovery and publication interface to the same group.

42. The registry composition entity of claim 40 wherein said processing module selects a node supporting one of said registries in said group to support said virtual registry.

43. The registry composition entity of claim 40 wherein said processing module reassigns the virtual node to a new network node when the supporting node leaves said network.

44. The registry composition entity of claim 40 wherein said processing module selects a node functioning as a super node to support said virtual registry.
